(19) United States
(12) Patent Application Publication
(10) Pub. No.: US 2024/0211993 A1
(43) Pub. Date: Jun. 27, 2024

(54) CONTENT ANALYSIS FOR BRAND SAFETY

(71) Applicant: NBCUNIVERSAL MEDIA, LLC, Universal City, CA (US)

(72) Inventors: Michael Levin, Westfield, NJ (US); Claire Smith, San Diego, CA (US); Kaitlyn Mitschele, Asbury, NJ (US); Stephane Krzywoglowy, New York, NY (US); Rebecca Mason, Merrick, NY (US); Collette Winn, Westport, CT (US); Ganesh Koramangala, HIllsborough, NJ (US); Han Tran, South Orange, NJ (US)

(73) Assignee: NBCUNIVERSAL MEDIA, LLC, Universal City, CA (US)

(21) Appl. No.: 18/069,821

(22) Filed: Dec. 21, 2022

Related U.S. Application Data
(60) Provisional application No. 63/299,836, filed on Jan. 14, 2022.

(51) Int. Cl. G06Q 30/0241

(52) U.S. Cl. CPC G06Q 30/0248

(57) ABSTRACT

According to at least one embodiment, one or more potential advertisement slots may be identified based on contextual characteristics relating to content. Such contextual characteristics may include tonality, sentiment and/or data that places potentially worrisome content in context. By identifying potential advertisement slots based on such characteristics, a seller develops a better understanding of content running on its own media platform(s), builds a greater level of trust with its advertiser partners, and generates better yield with respect to its advertisement inventory.

### CROSS-REFERENCE TO RELATED APPLICATION(S)

Pursuant to 35 U.S.C. § 119(e), this application claims the benefit of U.S. Provisional Patent Application No. 63/299,836, filed on Jan. 14, 2022, the contents of which are all hereby incorporated by reference herein in their entirety.

### BACKGROUND

Media platforms such as television and streaming networks sell advertisement slots (or spaces) to advertisers seeking to create or promote awareness about a product or brand. Advertisements may be run (or played back) in such slots alongside various forms of content, including entertainment content, sports content, news content, digital video, long-form full episodes, short-form content, etc.

Advertisers seeking to purchase advertisement slots may have brand safety concerns with respect to certain content. As such, an advertiser may choose not to purchase slots in which its advertisements would be run alongside certain content. Here, the concern may be based on an institutional fear that the advertised product or brand would be associated (by viewers) with content that is deemed controversial and, therefore, reflect poorly on the product or brand. Due to such concerns, an advertiser may choose not to purchase slots in which advertisements would be run alongside content belonging to one or more overly broad categories. By way of example, such overly broad categories may include any and all news content, any and all episodes of a television series (e.g., exclude all episodes in a season or all episodes in the entire series), any and all programs that are carried on a specific television or cable network, etc.

### SUMMARY

When an advertiser makes such choices, it may unnecessarily limit the reach of its advertisements. For example, the purchase restrictions may not be necessarily tailored to address the brand safety concerns that the advertiser actually has. In this regard, the choices made by the advertiser may be over-restrictive. In choosing not to purchase certain slots, the advertiser (or buyer) might be unnecessarily limiting its incremental reach.

From the perspective of the media platform (or seller), these choices may result in a reduced number of slots that is sold to the advertiser, thereby reducing advertising yield. This leads to an increased amount of unfilled inventory.

Aspects of the present disclosure are directed to better address brand safety concerns held by an advertiser, without unnecessarily limiting the incremental reach of its advertising campaign, by having an automated and technical workflow that analyzes content and reliably measures both the type of content that may be of concern to different advertises and the frequency with which the concerned content appears over a period of time. In this way, we create a technical fingerprint of the content that can be matched with an advertiser's safety profile to determine whether the content would be appropriate for the advertiser. Also, aspects of the present disclosure are directed to improving the comfort level of an advertiser when purchasing advertisement slots on the platform of a seller. According to at least one embodiment, one or more potential advertisement slots may be identified based on contextual characteristics relating to content. Such contextual characteristics may include tonality, sentiment and/or data that places potentially worrisome content in context. By identifying potential advertisement slots based on such characteristics, the seller is able to develop a better understanding of content running on its own platform(s), build a greater level of trust with its advertiser partners, and/or generate higher yield with respect to advertisement inventory.

According to at least one embodiment, a method of generating one or more suitability ratings includes: obtaining a client tolerance profile for a client; obtaining risk level information associated with content corresponding to the content information; and generating suitability ratings associated with the content based on the client tolerance profile and the risk level information.

According to at least one embodiment, an apparatus for generating one or more suitability ratings includes: a network communication unit configured to transmit and receive data; and one or more controllers. The one or more controllers are configured to: obtain a client tolerance profile for a client; obtain risk level information associated with content corresponding to the content information; and generate suitability ratings associated with the content based on the client tolerance profile and the risk level information.

According to at least one embodiment, a machine-readable non-transitory medium has stored thereon machine-executable instructions for generating one or more suitability ratings. The instructions include: obtaining a client tolerance profile for a client; obtaining risk level information associated with content corresponding to the content information; and generating suitability ratings associated with the content based on the client tolerance profile and the risk level information.

### BRIEF DESCRIPTION OF THE DRAWINGS

The above and other aspects and features of the present disclosure will become more apparent upon consideration of the following description of embodiments, taken in conjunction with the accompanying drawing figures.

FIG. 1 illustrates a diagram of workflow for identifying brand-safe inventory according to at least one embodiment.

FIG. 2 illustrates an example user interface for creating a client tolerance profile according to at least one embodiment.

FIG. 3 illustrates an example of a brand suitability scorecard that is produced based on output of a contextual optimizer (or a contextual decision engine) according to at least one embodiment.

FIG. 4 is a flowchart illustrating a method of generating one or more suitability ratings according to at least one embodiment.

FIG. 5 is an illustration of a computing environment according to at least one embodiment.

FIG. 6 is a block diagram of a device according to at least one embodiment

### DETAILED DESCRIPTION

In the following detailed description, reference is made to the accompanying drawing figures which form a part hereof, and which show by way of illustration specific embodiments of the present invention. It is to be understood by those of ordinary skill in this technological field that other embodiments may be utilized, and that structural, as well as procedural, changes may be made without departing from the scope of the present invention. Wherever possible, the same reference numbers will be used throughout the drawings to refer to the same or similar parts.

Aspects of this disclosure are directed to providing an advertiser with a greater degree of transparency into the content that is run on the media platform of a seller. This may enable the advertiser to decide, at a more granular level, which advertisement slots meet its brand safety concerns. For example, as will be described in more detail below with respect to one or more embodiments, content (e.g., one or more episodes of a television series) may first be scanned to identify content that is potentially worrisome with respect to brand safety concerns. The results of the scanning are provided to a contextual optimizer tool (or a contextual decision engine), which produces a suitability rating relating to the content. The suitability rating is based on not only the results of the scanning, but also (1) a client tolerance profile that captures preferences expressed by the advertiser and/or (2) data that may reveal contextual characteristics of the content.

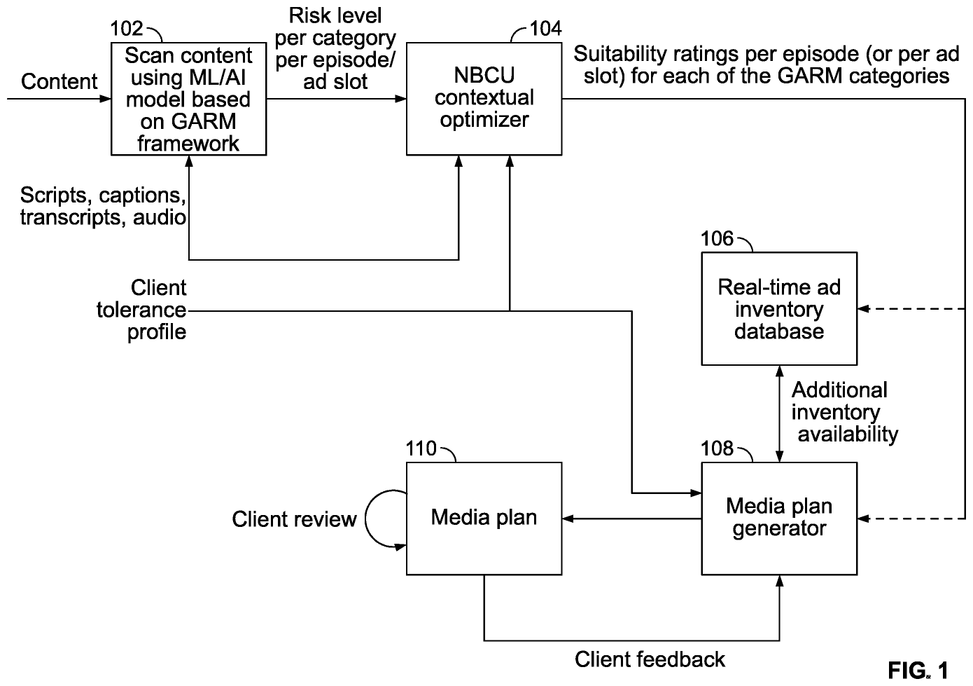

FIG. 1 illustrates a workflow diagram for identifying brand-safe inventory according to at least one embodiment. With reference to FIG. 1, content is input to a ML/AI (machine learning/artificial intelligence) model (see, e.g., block 102). The content may include a film or an episode of a television series (e.g., video files). The content may also include related data such as closed-captioning files and transcription files corresponding to the episode. Based on the content that is input, the ML/AI model assigns (or produces) a risk level with respect to each of a number of categories.

In at least one embodiment, the ML/AI model is trained to scan content based on categories enumerated in the Global Alliance for Responsible Media (GARM) framework, but the ML/AI model may also be trained based on other frameworks, which may include customized categories. In accordance with the GARM framework, the ML/AI model assigns a safety rating or risk level (e.g., floor, high risk, medium risk, or low risk) for each of a number of categories. Such categories may include: adult & explicit sexual content; arms & ammunition; death, injury, or military conflict; hate speech & acts of aggression; obscenity and profanity; illegal drugs/tobacco/e-cigarettes/vaping/alcohol; terrorism; crime & harmful acts to individuals and society, human rights violations; online piracy; spam or harmful content; and debated sensitive social issues.

For each of the noted categories, the GARM framework provides examples of content that would trigger a floor safety rating—that is, examples of content that would not be appropriate for any advertising support. For example, in the category of adult & explicit sexual content, examples of content that would trigger a floor safety rating may include illegal sale, distribution, and consumption of explicit or gratuitous depiction of sexual acts.

For each of the noted categories, the GARM framework also provides examples of sensitive content that would be appropriate for advertising supported by enhanced advertiser controls. For example, in the category of adult & explicit sexual content, examples of content that would trigger a risk level of “high risk” may include: suggestive sexual situations requiring adult supervision/approval or warnings. Examples of content that would trigger a risk level of “medium risk” may include: dramatic depiction of sexual acts or sexuality issues presented in the context of entertainment. Examples of content that would trigger a risk level of “low risk” may include: educational, informative, or scientific treatment of sexual subjects.

For each of one or more categories enumerated in the GARM framework, the ML/AI model scans content that is input, and assigns a rating or risk level (i.e., floor level, high risk, medium risk or low risk) based on examples provided by the GARM framework. For example, for a given content, the ML/AI model may assign a risk level of “low risk” in the category of adult & explicit sexual content. Concurrently, the ML/AI model may assign, to the same content, a risk level of “high risk” in the category of arms & ammunition.

As described earlier, the ML/AI model may be trained to scan content based on categories enumerated in the GARM framework. However, it is understood that the ML/AI model may be trained to scan content based on additional categories, e.g., categories not specifically listed in the GARM framework. Scanning based on such other categories may be performed in response to interest raised by one or more advertisers. As an example of categories, scanning may be based on specific keyword searches such as “car,” “gun,” “alcohol,” “explosion,” etc. Matches to keywords may be based on video imagery and/or audio that would be associated with the keyword. And when a segment of content is determined to be associated with a keyword or not associated with one or more keywords, the corresponding segment of content (or the entire content) may be marked as appropriate or inappropriate for the advertiser. In an aspect, while the content scanning based on keywords may be done dynamically when the advertiser inputs the keyword, the content may also be pre-scanned or tagged with high-frequency keywords that are of interest to advertisers.

As also described earlier, the ML/AI model assigns (or produces) a rating or risk level with respect to each of a number of categories. With continued reference to FIG. 1, these ratings/risk assessments are provided to a contextual optimizer (or a contextual decision engine) (see, e.g., block 104). For the content that is scanned by the ML/AI model, the contextual optimizer produces a suitability rating that is tailored to preferences expressed by the advertiser. This rating may be an overall rating that is based on category-specific suitability ratings that respectively correspond to the categories in the GARM framework. For example, the contextual optimizer may provide input to an advertisement platform that is provided by an ad server, such as Free Wheel. In this example, the ad server or the contextual optimizer may include an API that is able to automatically provide an ad identifier to Free Wheel or to a real-time ad inventory database, where the ad identifier corresponds to content that has been determined by the optimizer to be appropriate for the advertiser. This provides a scalable solution to automatically update the inventory that is available to the advertiser to purchase.

As will be described in more detail, the suitability ratings produced by the contextual optimizer may be based on not only the ratings/risk levels assigned by the ML/AI model, but also content-related data such as closed-captioning files and transcription files, as well as a client tolerance profile (or advertiser tolerance profile). Further, the contextual optimizer may receive additional information that would help it to more accurately ascertain a context, sentiment and/or tone of the content.

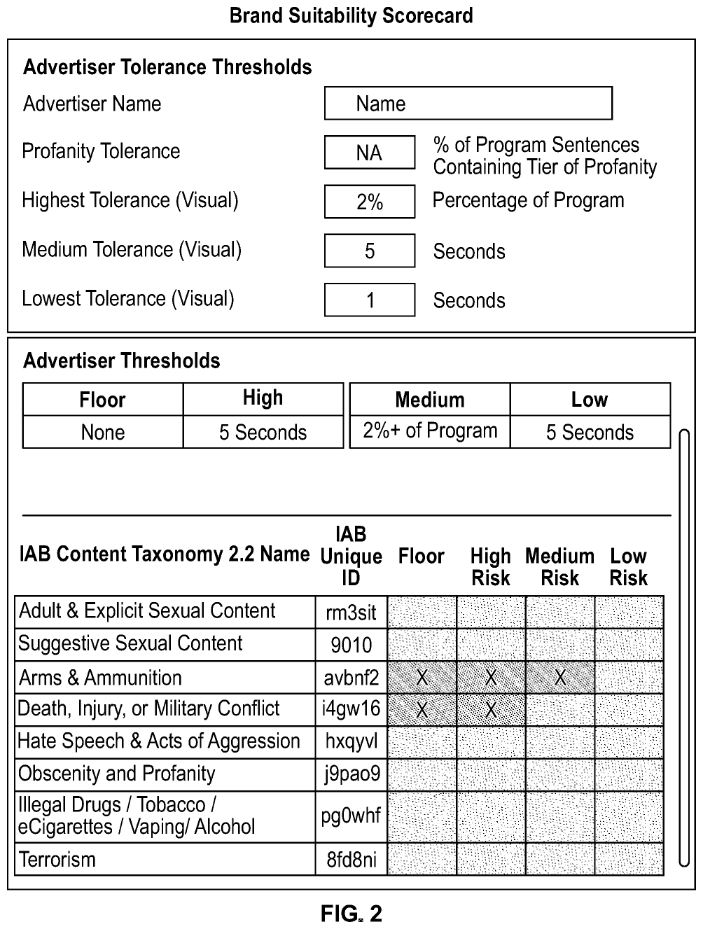

Information in the client tolerance profile may be unique to a specific advertiser. FIG. 2 illustrates an example user interface for creating a client tolerance profile according to at least one embodiment.

With reference to FIG. 2, the client tolerance profile may be created to capture the advertiser's tolerance with respect to individual categories covered in the GARM or another framework. For example, with respect to the category of adult & explicit sexual content, the profile may be created to capture that the advertiser would feel comfortable running its advertisements alongside content that has been assigned any risk level. In other words, with respect to the category of adult & explicit sexual content, content that is assigned a risk level of “floor,” “high risk,” “medium risk,” or “low risk” according to the GARM framework would be deemed acceptable from the advertiser's perspective.

As another example, with respect to the category of arms & ammunition, the profile may be created to capture that the advertiser would feel comfortable running its advertisements alongside content that has been assigned a risk level no higher than “low risk.” In other words, with respect to the category of arms & ammunition, content that is assigned a risk level of “floor,” “high risk,” or “medium risk” would be deemed unacceptable from the advertiser's perspective. It is understood that, according to at least one embodiment, the acceptability/unacceptability of content with respect to different risk levels (e.g., “floor,” “high risk,” “medium risk,” etc.) is individually selectable. For example, the acceptability/unacceptability of content with respect to the “floor” risk level may be selectable independently of the acceptability/unacceptability of the content with respect to other risk levels.

According to at least one further embodiment, the profile may be created to capture preference thresholds at a higher level of granularity. For example, as described earlier, with respect to the category of adult & explicit sexual content, content that is assigned a risk level of “high risk” would be deemed acceptable from the client's perspective. In this regard, the profile may be created to further capture that, despite the acceptability of “high risk” content, the advertiser prefers that its advertisements not be run (or placed) within a certain time interval (e.g., five seconds before and/or after) of playback of a segment that would be deemed “high risk.”

As described earlier, examples of content that would be classified as being “high risk” may include suggestive sexual situations requiring adult supervision/approval or warnings. Accordingly, the profile may be created to further capture that the advertiser's advertisements should not be run (or placed) within a certain time interval (e.g., three, five, 10 or any number of seconds) of playback of a segment or instance that triggers the “high risk” rating. Such a segment (or instance) may include suggestive sexual situations requiring adult supervision/approval or warnings. Accordingly, based on the client tolerance profile, the context optimizer may identify advertisement slots (or advertisement insertion points) that are sufficiently spaced apart from segments (or instances) that trigger a rating of “high risk.”

In another example, the profile may be created to capture that the advertiser prefers that its advertisements not be run (or placed) alongside content, where at least a certain percentage of the content triggers a given risk level for a given category. For example, the profile may capture that the advertiser prefers that its advertisements not be run alongside content where 2% or more of the total running length contains content that triggers a risk level of either “medium risk” or “low risk,” with respect to the category of adult & explicit sexual content.

As illustrated in FIG. 2, the profile may be created to capture that the advertiser prefers that its advertisements not be run (or placed) alongside content, where at least a certain percentage of the content triggers a given risk level for a given category. For example, the profile may specify whether the advertiser prefers that its advertisements not be run alongside content containing a GARM category (or another category) such as obscenity and profanity that is high risk, medium risk, or low risk. For each risk level associated with the category, the advertiser may further specify the acceptable tolerance for the risk level. For example, a high tolerance may mean 2% of the program, a medium tolerance may mean 5 seconds of the program, and a low tolerance may mean 1 second of the program. So an advertiser that has selected medium tolerance of low risk Obscenity and Profanity would advertise in a content that has a low risk of obscenity of profanity for 5 seconds. In another example, the profile may capture that the advertiser prefers that its advertisements not be run alongside content where 2% or more of the total running length contains content that triggers a risk level of medium risk with respect to the category of Obscenity and Profanity.

Based on the client tolerance profile, the contextual optimizer determines whether advertisement slots that would have been excluded (e.g., based purely on the results produced by the ML/AI model) may actually be suitable for the advertiser per its brand safety concerns. As will be further explained, the contextual optimizer may also be used to exclude content that may have otherwise been marked as suitable by the ML/AI model.

Determinations made by the contextual optimizer may be based on machine learning algorithms that determine a context of particular content. For example, the context may be determined based on the appearance (or frequency of appearance) of particular keywords in the closed-captioning files and/or transcription files. In this regard, certain keywords may map to broader categories (e.g., plotline) that serve to ascertain the tone or sentiment of the content. Here, the contextual optimizer may further illuminate ratings assigned by the ML/AI model.

For example, with respect to the category of Death, Injury or Military Conflict, the ML/AI model may assign particular content a rating of “medium risk” based on the content including an instance in which a fictional character is involved in an automobile crash. However, based on analyzing the scripts and captions surrounding this instance, the contextual optimizer may determine that the automobile crash was presented for comedic reasons—e.g., as part of a joke, or to trigger laughter. In contrast to the ML/AI model (which may have raised a potential brand safety concern with respect to Death, Injury or Military Conflict), the contextual optimizer may determine that, because the triggering instance was presented in a comedic context, it does not warrant a concern with regards to brand safety. Accordingly, the contextual optimizer is able to place potentially worrisome content in a broader context.

As another example, with respect to the category of Arms & Ammunition, the contextual optimizer may similarly recognize a difference between an instance in which a fictional character aims a gun at another fictional character and an instance in which the fictional character plays with a toy gun and, in doing so, aims the toy gun at the other character. Accordingly, the contextual optimizer helps to improve the possibility that purchase choices ultimately made by an advertiser will not be overly restrictive.

Concurrently, the contextual optimizer may help to identify potential concerns that might not be flagged by the ML/AI model. For example, the advertiser may request that its advertisements not be run alongside any content dealing with guns. As such, the corresponding client tolerance profile may be generated to indicate that, with respect to the category of Arms & Ammunition, content that is assigned a risk level of “floor,” “high risk,” “medium risk,” or “low risk” may be deemed unacceptable from the advertiser's perspective.

A given episode of a television series may not include any segments or instances that would cause the ML/AI model to assign any of the above risk levels to the episode. However, the episode may include a significant amount of discussion between characters regarding firearms, including the purchase of guns, the use of guns, etc. In this situation, the context optimizer may recognize the purchase/use of guns as being a sentiment (or theme) or underlying context of the episode, and output information indicating this sentiment or context. Sharing such information with the advertiser provides a greater degree of transparency with respect to the content running on the seller's platform and, therefore, helps to build trust with the advertiser.

As another example, the advertiser may request that its advertisements not be run alongside any content dealing with the theme of adultery. An episode of a television series may not include any segments or instances that would cause the ML/AI model to assign any risk levels associated with, e.g., the category of adult & explicit sexual content. However, the context optimizer may recognize the topic of adultery as being a sentiment (or theme) or underlying context of the episode.

Similarly, if the ML/AI model performs visual scanning alone, the ML/AI model may not identify running themes or subtexts that may discomfort an advertiser. For example, the visual content of an opinion news show may be fairly generic and, therefore, may not raise any flags with respect to categories of the GARM framework. However, audio discussion (e.g., expressing viewpoints of individual speakers) may introduce themes or subtexts that may discomfort an advertiser. Such themes or subtexts may be identified by the context optimizer. As such, the context optimizer may be utilized to identify additional categories that are not captured in the GARM framework. Analysis with respect to such additional categories may be carried out over time.

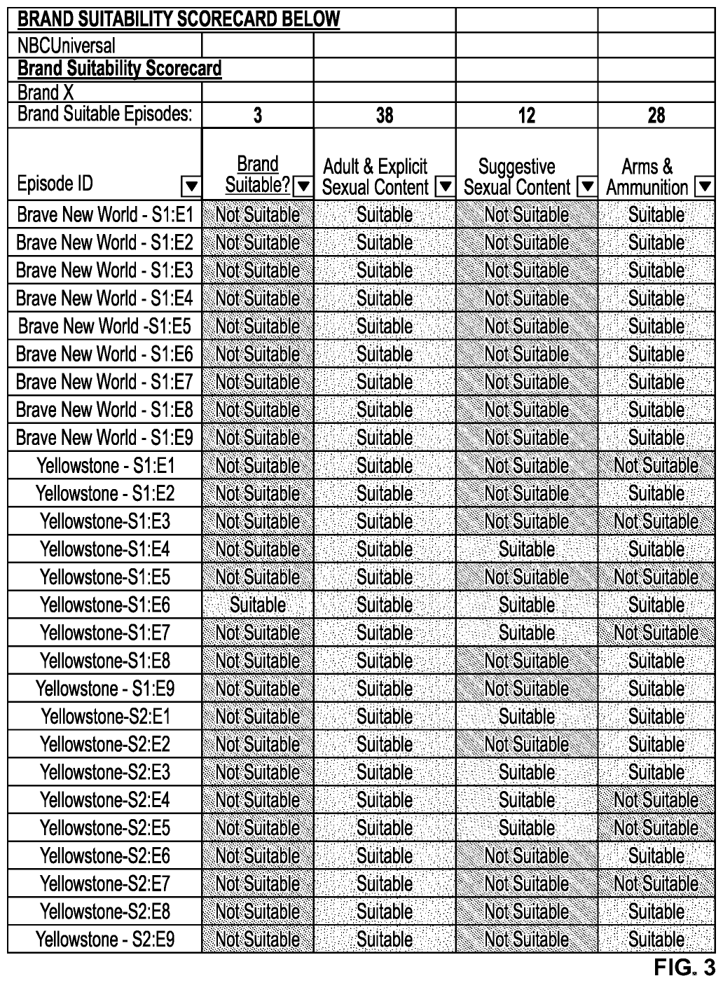

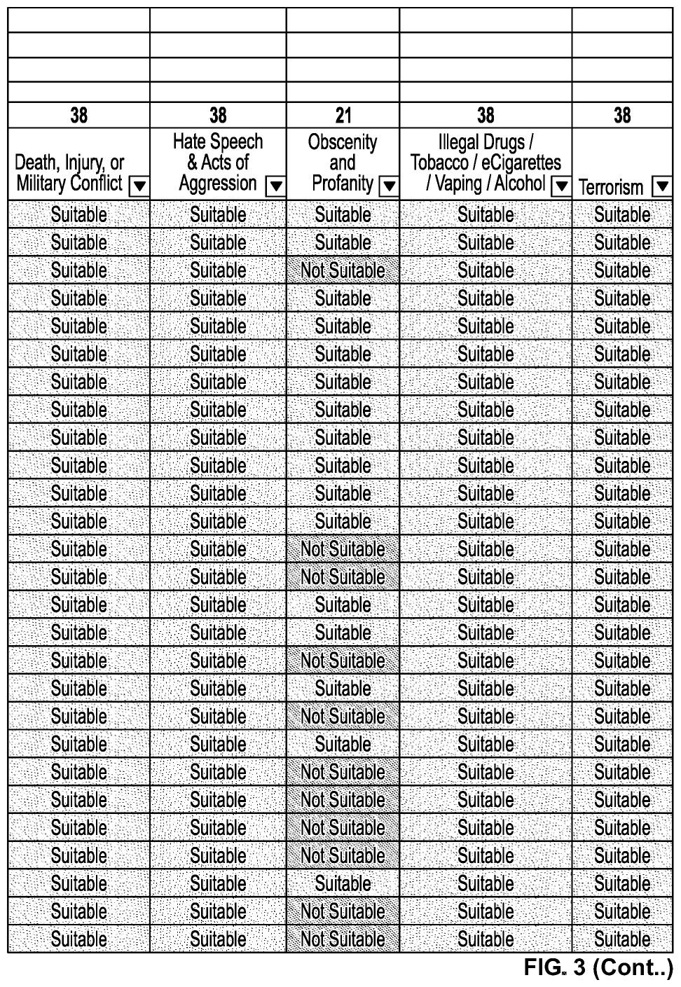

FIG. 3 illustrates an example of a brand suitability scorecard that is produced based on the output of the contextual optimizer (or the contextual decision engine) according to at least one embodiment. Each row of the scorecard provides suitability ratings for respective content (e.g., a respective episode of a particular television series) that has been analyzed. Individual columns of the scorecard correspond to individual categories specified in the GARM framework. Although the GARM framework is used as an example here, other frameworks, including keywords may be used instead of or in addition to the GARM framework. In each of these columns, a value of “Suitable” indicates that the corresponding content meets the conditions captured in the client tolerance profile (see, e.g., FIG. 2). Values in the column labeled “Brand Suitable?” indicate an overall suitability rating based on the individual columns noted earlier. For example, if a particular episode meets the conditions captured in the client tolerance profile for all categories specified in the GARM framework, then its value in the column labeled “Brand Suitable?” is set to “Suitable.” Otherwise, its value in this column is set to “Not Suitable.”

As illustrated in FIG. 3, an episode of the series “Yellowstone” is indicated as having an overall suitability rating of “Suitable.” Here, the ML/AI model may have assigned a risk level for the various categories within the GARM framework. However, the context optimizer may then pair the results generated by the ML/AI model with the advertiser profile to determine whether the content triggers a Not Suitable rating with respect to any category selected by the advertiser as relevant. If a Not Suitable rating is assigned to a particular category, then a Not Suitable rating may be assigned to the overall content. By contrast, if all categories are found suitable for a piece of content, then that content may be marked as Suitable for the brand. In this example, Episode 6 from Season 1 of Yellowstone would become available to the advertiser based on the GARM framework analysis and the advertiser's profile.

It can be appreciated that varying the thresholds that are captured in the client tolerance profile (see, e.g., FIG. 2) may cause the ratings in the brand suitability scorecard (see, e.g., FIG. 3) to change accordingly. In general, the less restrictive the advertiser's requirements, the larger the reach that may be afforded to the advertiser. Conversely, the more restrictive the requirements, the smaller the reach that may be afforded.

As described earlier, an overall suitability rating (e.g., “Suitable”) may correspond to a given episode. According to at least one embodiment, individual suitability ratings may be assigned to individual segments of a given episode. For example, the given episode may be divided into multiple segments of equal or varying lengths (e.g., 10 seconds, 30 seconds, 1 minute, 2 minutes, 5 minutes, etc.), and each of the segments may be indicated as having a suitability rating (e.g., “Suitable” or “Not Suitable”). As described earlier with reference to the client tolerance profile of FIG. 2, an advertiser may prefer that its advertisements not be run (or placed) within a certain time interval (e.g., five seconds before and/or after) of playback of a particular segment. Accordingly, advertisement slots that, within a given time threshold, precede or follow a segment indicated as being “Suitable” (or “Not Suitable”) may be included (or excluded). In this manner, advertisers may be afforded more flexibility and audience reach.

According to at least one embodiment, a data structure (e.g., an array, a table or an appropriate or suitable data structure) may be utilized to store and share the information of FIG. 3. For example, such a data structure may store the overall suitability ratings for individual episodes and/or suitability ratings for individual segments of one or more given episodes. Each suitable episode or segment may be associated with a unique identifier, which is then associated with the advertiser as Suitable or Not Suitable. As another example, such a data structure may store, more generally, information addressing whether each of one or more episodes is brand suitable. The data structure may contain different types of content identifiers. For example, with respect to an episodic, the data structure may include one or more identifiers that identifies at least one of the title of the series, the season, the episode, and the particular segment within the episode, or any combination thereof. The data structure may also identify the brand or profile to which suitability is being determined (e.g., a profile for a consumer goods company or for a financial institution).

As was described with reference to FIG. 3, the contextual optimizer produces suitability ratings for each content (e.g., each episode of a television series). As such, the contextual optimizer identifies episodes which are believed to be safe choices for the advertiser to consider when purchasing advertisement slots. With reference back to FIG. 1, an advertisement campaign may be operationalized based on that framework. For example, the suitability ratings may be provided to a real-time ad inventory database, which may access forecasting tools (see, e.g., block 106). Accordingly, it is possible to quantify the value of these episodes with respect to impressions (or numbers of viewers).

The output of the contextual optimizer may include the suitability data as shown in FIG. 3 and/or references to advertisements slots (e.g., advertisement slots corresponding to a particular episode of “Yellowstone”, as described earlier with reference to FIG. 3). Although FIG. 3 shows episode IDs, the output of the contextual optimizer may also include a content identifier associated with a show or segment. This output can be provided to a media plan generator and/or a real-time ad inventory database so that available slots may be incorporated and automatically updated when producing a media plan for the advertiser (see, e.g., block 106 and/or 108 of FIG. 1). The media plan generator produces a media plan, which may then be reviewed by and/or with the advertiser (see, e.g., block 110 of FIG. 1). In presenting the media plan to the advertiser, it may be explained that the plan includes recommendations based on preferences it had expressed, and that the recommendations includes content that was ultimately determined to be acceptable with respect to its brand safety concerns.

In addition, regarding additional advertisement slots identified by the context optimizer, any accompanying increase in the number of impressions may also be presented to the advertiser. For example, if the advertiser had excluded 25% of the seller's inventory based purely on the results produced by the ML/AI model, and the context optimizer deems that only 20% of that inventory need be excluded, the increase in the number of impressions that would be afforded by that “recovered” 5% of the inventory may also be presented to the advertiser.

With continued reference to FIG. 1, client feedback regarding the media plan may be provided back to the media plan generator. For example, the feedback may indicate the inventory that the advertiser has approved for purchase. Such feedback is provided to the media plan generator, and then the booking process may proceed.

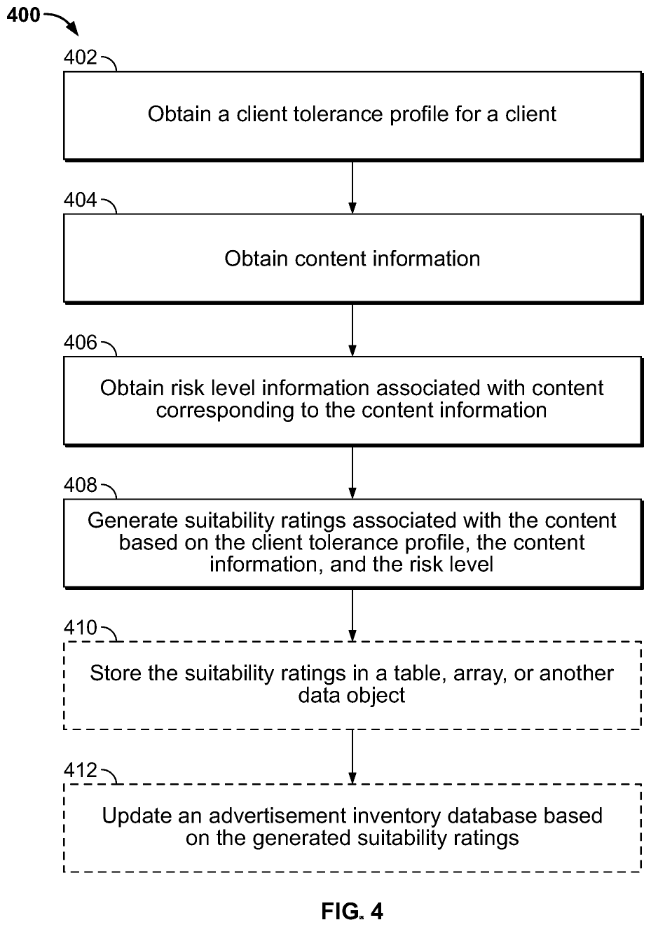

FIG. 4 illustrates a flowchart of a method 400 of generating one or more suitability ratings. Although the blocks listed in FIG. 4 are provided in a certain order, the ordering is optional, and blocks may be omitted.

At block 402, a client tolerance profile is obtained for a client. In an aspect, obtaining the client tolerance profile includes obtaining categories for which the client is interested in, the acceptable risk level for each category (e.g., low, medium, high risk) and a tolerance threshold (e.g., low, medium, high tolerance) with respect to each risk level for each selected category. For example, at least one threshold similar to the thresholds captured in the client tolerance profile of FIG. 2 is obtained.

At block 404, content information is obtained. In an aspect, obtaining the content information includes obtaining at least one of script information, caption information, transcript information or audio file information. For example, as described earlier with reference to block 102 of FIG. 1, content is input. The content may include a film or an episode of a television series (e.g., video files). The content may also include related data such as closed-captioning files and transcription files corresponding to the episode.

At block 406, risk level information associated with content corresponding to the content information is obtained. In an aspect, obtaining the risk level information includes obtaining the risk level information associated with one or more segments of content based on a machine learning model. For example, as described earlier with reference to block 102 of FIG. 1, the ML/AI model scans content that is input, and assigns a rating or risk level (i.e., floor level, high risk, medium risk or low risk) to an entire episode or to one or more segments of an episode based on examples provided by the GARM framework.

At block 408, suitability ratings associated with the content based on the client tolerance profile, the content information, and the risk level information are generated. For example, as described earlier with reference to block 104 of FIG. 1, for the content that is scanned by the ML/AI model, the contextual optimizer receives the client tolerance profile, the risk level information, and/or content information and produces a suitability rating that is tailored to preferences expressed by the advertiser. This rating may be an overall rating that is based on category-specific suitability ratings that respectively correspond to the categories in the GARM framework.

In an aspect, generating the suitability ratings includes determining whether one or more segments of the content are acceptable to the client based on the client tolerance profile, the content information, and/or the risk level information. For example, as described earlier with reference to FIG. 3, individual suitability ratings may be assigned to individual segments of a given episode. In this example, the given episode may be divided into multiple segments of equal or varying lengths (e.g., 10 seconds, 30 seconds, 1 minute, 2 minutes, 5 minutes, etc.), and each of the segments may be indicated as having a suitability rating (e.g., “Suitable” or “Not Suitable”). In another example, which is shown in FIG. 3, the suitability rating may refer to an entire episode.

In a further aspect, determining whether the one or more segments of the content are acceptable to the client includes determining whether the one or more segments of the content are separated, in time, from an adjacent advertisement slot by a time threshold. Such further determination may be based on a client profile. For example, as described earlier with reference to FIG. 2, the profile may further capture that, despite the acceptability of “high risk” content, the advertiser prefers that its advertisements not be run (or placed) within a certain time interval (e.g., five seconds before and/or after) of playback of a segment that would be deemed “high risk.” Accordingly, based on the client tolerance profile, the context optimizer may identify advertisement slots (or advertisement insertion points) that are sufficiently spaced apart from segments (or instances) that trigger a rating of “high risk.”

In an aspect, the suitability ratings indicate a suitability of the one or more segments of the content to the client, and the suitability ratings are associated with a client identifier identifying the client.

At block 410, the suitability ratings may be stored in a data structure such as a table, array, or another data object (see, e.g., the brand suitability scorecard of FIG. 3). The data structure may include an identifier that identifies the content and/or a segment of the content. For each identifier, the data structure may contain corresponding information regarding the suitability of the content and/or the segment of content for the advertiser based on the advertiser profile.

At block 412, an advertisement inventory database may be updated based on the generated suitability ratings. For example, as described earlier with reference to block 106 of FIG. 1, the suitability ratings may be provided to a real-time ad inventory database, which may access forecasting tools. Based on the suitability ratings, the real-time ad inventory database may determine that additional advertisement inventory is available to the advertiser associate the additional advertisement inventory with the advertiser's media profile.

In an aspect, updating the advertisement inventory database includes determining an increase in a number of impressions corresponding to the updating of the advertisement inventory database.

For example, as described earlier with reference to block 106 of FIG. 1, it is possible to quantify the value of these episodes with respect to impressions (or numbers of viewers). As described earlier with reference to FIG. 1, regarding additional advertisement slots identified by the contextual optimizer, any accompanying increase in the number of impressions may also be presented to the advertiser.

In at least some embodiments, features or aspects of earlier-described embodiments may be implemented using one or more software or hardware computer systems that may further include (or may be operably coupled to) one or more hardware memory systems for storing information including databases for storing, accessing, and querying various content, encoded data, shared addresses, metadata, etc. In hardware implementations, the one or more computer systems incorporate one or more computer processors and controllers.

The components of various embodiments described herein may each include a hardware processor of the one or more computer systems, and, in one embodiment, a single processor may be configured to implement the various components. For example, in one embodiment, the block 104, the block 108, or combinations thereof, may be implemented as separate hardware systems, or may be implemented as a single hardware system. The hardware system may include various transitory and non-transitory memory for storing information, wired and wireless communication receivers and transmitters, displays, and input and output interfaces and devices. The various computer systems, memory, and components of the system may be operably coupled to communicate information, and the system may further include various hardware and software communication modules, interfaces, and circuitry to enable wired or wireless communication of information.

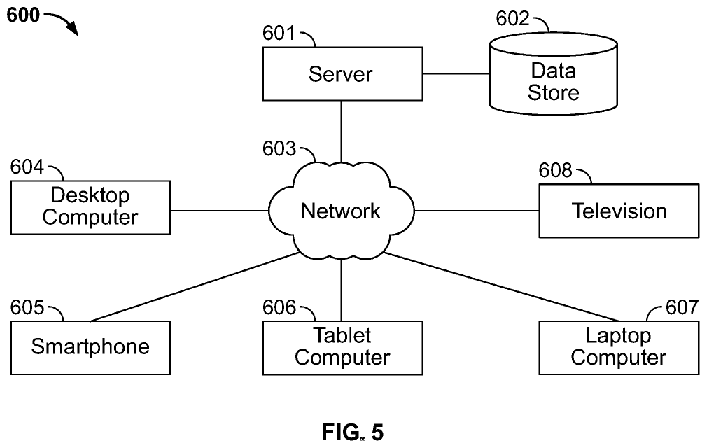

In selected embodiments, features and aspects described herein may be implemented within a computing system 600, as shown in FIG. 5, which may include one or more computer servers 601. The server 601 may be operatively coupled to one or more data stores 602 (e.g., databases, indexes, files, or other data structures). The server 601 may connect to a data communication network 603 including a local area network (LAN), a wide area network (WAN) (e.g., the Internet), a telephone network, a satellite or wireless communication network, or some combination of these or similar networks.

One or more client devices 604, 605, 606, 607, 608 may be in communication with the server 601, and a corresponding data store 602 via the data communication network 603. Such client devices 604, 605, 606, 607, 608 may include, for example, one or more laptop computers 607, desktop computers 604, smartphones and mobile phones 605, tablet computers 606, televisions 608, or combinations thereof. In operation, such client devices 604, 605, 606, 607, 608 may send and receive data or instructions to or from the server 601 in response to user input received from user input devices or other input. In response, the server 601 may serve data from the data store 602, alter data within the data store 602, add data to the data store 602, or the like, or combinations thereof.

In selected embodiments, the server 601 may transmit one or more media files including audio and/or video content, encoded data, generated data, and/or metadata from the data store 602 to one or more of the client devices 604, 605, 606, 607, 608 via the data communication network 603. The devices may output the audio and/or video content from the media file using a display screen, projector, or other display output device. In certain embodiments, the system 600 configured in accordance with features and aspects described herein may be configured to operate within or support a cloud computing environment. For example, a portion of, or all of, the data store 602 and server 601 may reside in a cloud server.

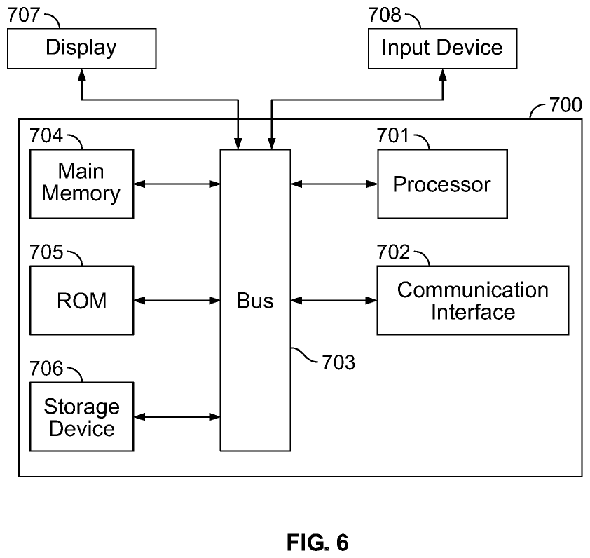

With reference to FIG. 6, an illustration of an example computer 700 is provided. One or more of the devices 604, 605, 606, 607, 608 of the system 600 may be configured as or include such a computer 700. In addition, one or more components of the block 104 or the block 108 may be configured as or include the computer 700.

In selected embodiments, the computer 700 may include a bus 703 (or multiple buses) or other communication mechanism, a processor 701, main memory 704, read only memory (ROM) 705, one or more additional storage devices 706, and/or a communication interface 702, or the like or sub-combinations thereof. Embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. In all embodiments, the various components described herein may be implemented as a single component, or alternatively may be implemented in various separate components.

The bus 703 or other communication mechanism, including multiple such buses or mechanisms, may support communication of information within the computer 700. The processor 701 may be connected to the bus 703 and process information. In selected embodiments, the processor 701 may be a specialized or dedicated microprocessor configured to perform particular tasks in accordance with the features and aspects described herein by executing machine-readable software code defining the particular tasks. Main memory 704 (e.g., random access memory—or RAM—or other dynamic storage device) may be connected to the bus 703 and store information and instructions to be executed by the processor 701. Main memory 704 may also store temporary variables or other intermediate information during execution of such instructions.

ROM 705 or some other static storage device may be connected to a bus 703 and store static information and instructions for the processor 701. The additional storage device 706 (e.g., a magnetic disk, optical disk, memory card, or the like) may be connected to the bus 703. The main memory 704, ROM 705, and the additional storage device 706 may include a non-transitory computer-readable medium holding information, instructions, or some combination thereof—for example, instructions that, when executed by the processor 701, cause the computer 700 to perform one or more operations of a method as described herein. The communication interface 702 may also be connected to the bus 703. A communication interface 702 may provide or support two-way data communication between the computer 700 and one or more external devices (e.g., other devices contained within the computing environment).

In selected embodiments, the computer 700 may be connected (e.g., via the bus 703) to a display 707. The display 707 may use any suitable mechanism to communicate information to a user of a computer 700. For example, the display 707 may include or utilize a liquid crystal display (LCD), light emitting diode (LED) display, projector, or other display device to present information to a user of the computer 700 in a visual display. One or more input devices 708 (e.g., an alphanumeric keyboard, mouse, microphone) may be connected to the bus 703 to communicate information and commands to the computer 700. In selected embodiments, one input device 708 may provide or support control over the positioning of a cursor to allow for selection and execution of various objects, files, programs, and the like provided by the computer 700 and displayed by the display 707.

The computer 700 may be used to transmit, receive, decode, display, etc. one or more video files. In selected embodiments, such transmitting, receiving, decoding, and displaying may be in response to the processor 701 executing one or more sequences of one or more instructions contained in main memory 704. Such instructions may be read into main memory 704 from another non-transitory computer-readable medium (e.g., a storage device).

Execution of sequences of instructions contained in main memory 704 may cause the processor 701 to perform one or more of the procedures or steps described herein. In selected embodiments, one or more processors in a multi-processing arrangement may also be employed to execute sequences of instructions contained in main memory 704. Alternatively, or in addition thereto, firmware may be used in place of, or in connection with, software instructions to implement procedures or steps in accordance with the features and aspects described herein. Thus, embodiments in accordance with features and aspects described herein may not be limited to any specific combination of hardware circuitry and software.

Non-transitory computer readable medium may refer to any medium that participates in holding instructions for execution by the processor 701, or that stores data for processing by a computer, and include all computer-readable media, with the sole exception being a transitory, propagating signal. Such a non-transitory computer readable medium may include, but is not limited to, non-volatile media, volatile media, and temporary storage media (e.g., cache memory). Non-volatile media may include optical or magnetic disks, such as an additional storage device. Volatile media may include dynamic memory, such as main memory. Common forms of non-transitory computer-readable media may include, for example, a hard disk, a floppy disk, magnetic tape, or any other magnetic medium, a CD-ROM, DVD, Blu-ray or other optical medium, RAM, PROM, EPROM, FLASH-EPROM, any other memory card, chip, or cartridge, or any other memory medium from which a computer can read.

In selected embodiments, the communication interface 702 may provide or support external, two-way data communication to or via a network link. For example, the communication interface 702 may be a wireless network interface controller or a cellular radio providing a data communication network connection. Alternatively, the communication interface 702 may include a LAN card providing a data communication connection to a compatible LAN. In any such embodiment, the communication interface 702 may send and receive electrical, electromagnetic, or optical signals conveying information.

A network link may provide data communication through one or more networks to other data devices (e.g., client devices as shown in the computing system 600). For example, a network link may provide a connection through a local network of a host computer or to data equipment operated by an Internet Service Provider (ISP). An ISP may, in turn, provide data communication services through the Internet. Accordingly, a computer 700 may send and receive commands, data, or combinations thereof, including program code, through one or more networks, a network link, and communication interface 702. Thus, the computer 700 may interface or otherwise communicate with a remote server (e.g., server 601), or some combination thereof.

The various devices, modules, terminals, and the like described herein may be implemented on a computer by execution of software comprising machine instructions read from computer-readable medium, as discussed above. In certain embodiments, several hardware aspects may be implemented using a single computer; in other embodiments, multiple computers, input/output systems and hardware may be used to implement the system.

For a software implementation, certain embodiments described herein may be implemented with separate software modules, such as procedures and functions, each of which performs one or more of the functions and operations described herein. The software codes can be implemented with a software application written in any suitable programming language and may be stored in memory and executed by a controller or processor.

The foregoing described embodiments and features are merely exemplary and are not to be construed as limiting the present invention. The present teachings can be readily applied to other types of apparatuses and processes. The description of such embodiments is intended to be illustrative, and not to limit the scope of the claims. Many alternatives, modifications, and variations will be apparent to those skilled in the art.

1. A method of generating one or more suitability ratings, the method comprising:
obtaining a client tolerance profile for a client;
obtaining content information comprising at least one of script information, caption information, transcript information or audio file information;
obtaining risk level information associated with content corresponding to the content information, wherein the content comprises a plurality of segments, each of the segments having a time duration shorter than a time duration of the content, and wherein each segment of the plurality of segments is assigned a corresponding risk level; and
generating suitability ratings associated with one or more segments of the plurality of segments based on the client tolerance profile, the content information and the risk level information,
wherein generating the suitability ratings comprises determining whether the one or more segments are acceptable to the client based on the client tolerance profile, the risk level information, and the at least one of the script information, the caption information, the transcript information, or the audio file information, and
wherein determining whether the one or more segments of the content are acceptable to the client comprises determining whether the one or more segments of the content are separated from an advertisement slot by a spacing greater than or equal to a time threshold.

2. The method of claim 1, wherein obtaining the client tolerance profile comprises obtaining at least one tolerance threshold with respect to one or more categories of a Global Alliance for Responsible Media (GARM) framework.

3-4. (canceled)

5. The method of claim 1, wherein each segment of the plurality of segments is assigned a risk level of low, medium, or high.

6. (canceled)

7. (canceled)

8. The method of claim 1, wherein the suitability ratings indicate a suitability of the one or more segments to the client, and the suitability ratings are associated with a client identifier identifying the client.

9. The method of claim 1, further comprising storing the suitability ratings in a table, array, or another data object, wherein the table comprises identifiers for the one or more segments and the corresponding suitability rating for each segment of the one or more segments as related to the client.

10. The method of claim 1, further comprising updating an advertisement inventory database associated with the client based on the generated suitability ratings.

11. The method of claim 10, wherein updating the advertisement inventory database comprises determining an increase in a number of advertisement slots available to the client based on the suitability ratings.

12. An apparatus for generating one or more suitability ratings, the apparatus comprising:
a transceiver configured to transmit and receive data; and
one or more controllers configured to:
obtain a client tolerance profile for a client;
obtain content information comprising at least one of script information, caption information, transcript information or audio file information;
obtain risk level information associated with content corresponding to the content information, wherein the content comprises a plurality of segments, each of the segments having a time duration shorter than a time duration of the content, and wherein each segment of the plurality of segments is assigned a corresponding risk level; and
generate suitability ratings associated with one or more segments of the plurality of segments based on the client tolerance profile, the content information and the risk level information,
wherein the one or more controllers are further configured to generate the suitability ratings by determining whether the one or more segments are acceptable to the client based on the client tolerance profile, the risk level information, and the at least one of the script information, the caption information, the transcript information, or the audio file information, and
wherein the one or more controllers are further configured to determine whether the one or more segments of the content are acceptable to the client by determining whether the one or more segments of the content are separated from an advertisement slot by a spacing greater than or equal to a time threshold.

13. The apparatus of claim 12, wherein the one or more controllers are further configured to obtain the client tolerance profile by obtaining at least one tolerance threshold with respect to one or more categories of a Global Alliance for Responsible Media (GARM) framework.

14-15. (canceled)

16. The apparatus of claim 12, wherein each segment of the plurality of segments is assigned a risk level of low, medium, or high.

17. (canceled)

18. (canceled)

19. The apparatus of claim 12, wherein the suitability ratings indicate a suitability of the one or more segments to the client, and the suitability ratings are associated with a client identifier identifying the client.

20. A machine-readable non-transitory medium having stored thereon machine-executable instructions for generating one or more suitability ratings, the instructions comprising:
obtaining a client tolerance profile for a client;
obtaining content information comprising at least one of script information, caption information, transcript information or audio file information;
obtaining risk level information associated with content corresponding to the content information, wherein the content comprises a plurality of segments, each of the segments having a time duration shorter than a time duration of the content, and wherein each segment of the plurality of segments is assigned a corresponding risk level; and
generating suitability ratings associated with one or more segments of the plurality of segments based on the client tolerance profile, the content information and the risk level information,
wherein generating the suitability ratings comprises determining whether the one or more segments are acceptable to the client based on the client tolerance profile, the risk level information, and the at least one of the script information, the caption information, the transcript information, or the audio file information, and
wherein determining whether the one or more segments of the content are acceptable to the client comprises determining whether the one or more segments of the content are separated from an advertisement slot by a spacing greater than or equal to a time threshold.
